(19) United States
(12) Patent Application Publication
(10) Pub. No.: US 2016/0085226 A1
(43) Pub. Date: Mar. 24, 2016

(54) ENGINEERING TOOL AND PROGRAMMABLE LOGIC CONTROLLER

(71) Applicant: MITSUBISHI ELECTRIC CORPORATION, Chiyoda-ku, Tokyo (JP)

(72) Inventor: Shuichi TANAKA, Tokyo (JP)

(73) Assignee: Mitsubishi Electric Corporation, Tokyo (JP)

(21) Appl. No.: 14/767,982

(22) PCT Filed: Apr. 4, 2013
(86) PCT No.: PCT/JP2013/060397

§ 371 Date: Aug. 14, 2015

(51) Int. Cl. G05B 19/05

(52) U.S. Cl. CPC G05B 19/056; G05B 2219/13034; G05B 2219/13004

(57) ABSTRACT

An engineering tool includes a program editing unit that designates a device by selecting a label allocated to the device and edits a sequence program and a label setting management unit that manages the setting of the label. The label setting management unit includes an individual processing setting unit that is capable of setting individual processing to be performed by the device designated by the label. It does this by associating a function corresponding to the individual processing with the label.

### FIELD

The present invention relates to an engineering tool and a programmable logic controller.

### BACKGROUND

An engineering tool is a tool for editing a sequence program to be run by a programmable logic controller (PLC) system or the like. For example, a known type of engineering tool designates a device according to its selected label and edits a sequence program. The label is allocated to a device in advance. The engineering tool manages the setting of the labels with a label editor. The conventional setting of a label with the label editor includes definitions of the label name and the data type.

When such a conventional label editor is used, individual processing performed by a device designated by a label requires setting by programming with a program editor or the like in addition to working with the label editor. This creates a problem in that the setting and management of individual processing performed by a device becomes complex, the program editing becomes complex, and the size of sequence programs increases.

### CITATION LIST

### Patent Literature

Patent Literature 1: Japanese Patent Application Laid-Open No. 10-63315

### SUMMARY

### Technical Problem

The present invention has been achieved in view of the above, and the objective thereof is to provide an engineering tool and a programmable logic controller that can simplify individual setting and management of a device; can simplify program editing; and further can reduce the size of a sequence program.

### Solution to Problem

In order to solve the problem and achieve the objective, the present invention relates to an engineering tool, that includes a program editing unit designating a device by selecting a label allocated to the device and editing a sequence program; and a label setting management unit that manages a setting of the label. The label setting management unit includes an individual processing setting unit that is capable of setting, by associating a function corresponding to the individual processing with the label, individual processing on the device designated by the label.

### Advantageous Effects of Invention

In the present invention, a label setting management unit allows individual processing setting units to set, by associating a function corresponding to the individual processing with a label, a device designated by a label to perform an individual processing. The label setting management unit is capable of setting the individual processing of the device by tying the individual processing to the label allocated to the device. The label setting management unit centrally manages the label and the individual processing the device is to be set to perform. An operator can designate a device and set individual processing in a collective manner by using a label editor. In this manner, the engineering tool has the capability to provide simplified setting and management of individual processing of a device and simplified program editing. Additionally, the engineering tool provides the capability to reduce the size of a sequence program.

### BRIEF DESCRIPTION OF DRAWINGS

FIG. 1 is a block diagram illustrating the schematic configuration of an engineering tool according to an embodiment of the present invention.

FIG. 2 is a diagram illustrating the configuration of hardware including the engineering tool installed therein.

FIG. 3 is a diagram illustrating a system including a programmable logic controller, a personal computer, and a sensor.

FIG. 4 is a diagram illustrating an exemplary operation screen including a label editor.

FIG. 5 is a diagram illustrating example settings of labels.

FIG. 6 is a diagram illustrating another example setting of a label.

FIG. 7 is a diagram explaining program editing and transmission of a sequence program to the PLC by the engineering tool.

FIG. 8 is a diagram illustrating the state in which the sequence program is running in the PLC.

FIG. 9 is a diagram explaining an operation at the occurrence of an error during the operation of the sequence program in the PLC.

FIG. 10 is a flowchart of the procedure for converting a setting managed by a label setting management unit to a program for individual processing.

FIG. 11 is a flowchart of the procedure for registration processing for range check.

FIG. 12 is a flowchart explaining automatic assignment of an error number.

FIG. 13 is a diagram illustrating example error numbers and error messages stored by an error number management unit.

FIG. 14 is a diagram illustrating example function blocks to be registered for the range check.

FIG. 15 is a diagram illustrating a main program that incorporates the function blocks.

FIG. 16 is a diagram illustrating a system including a PLC, a PC, an indicator, and a plurality of sensors.

### DESCRIPTION OF EMBODIMENTS

Exemplary embodiments of an engineering tool and a programmable logic controller according to the present invention will be described in detail with reference to the drawings. The present invention is not limited to the embodiment.

### Embodiment

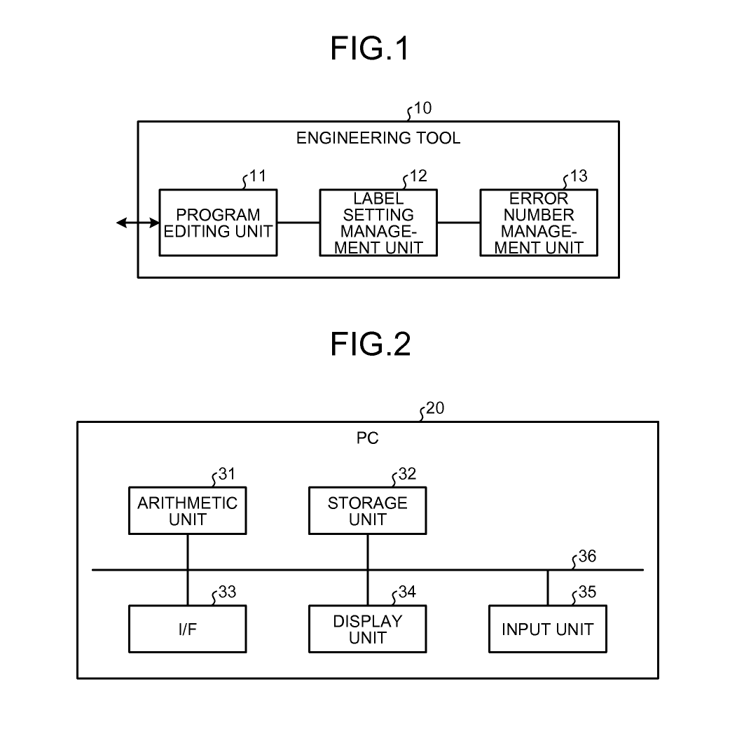

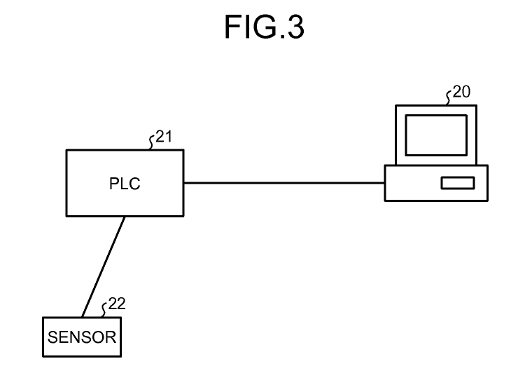

FIG. 1 is a block diagram illustrating the schematic configuration of an engineering tool according to an embodiment of the present invention. FIG. 2 is a diagram illustrating the configuration of hardware including the engineering tool installed therein. FIG. 3 is a diagram illustrating a system including a programmable logic controller (PLC), a personal computer (PC), and a sensor.

An engineering tool 10 is a tool for editing a sequence program to be run in a PLC system including a PLC 21. The engineering tool 10 is implemented with hardware, for example a PC 20, that includes engineering tool software installed therein. The engineering tool 10 transmits an edited sequence program to the PLC 21.

The PC 20 includes, for example, an arithmetic unit 31 that is a CPU (Central Processing Unit), a storage unit 32 including a ROM (Read Only Memory), a RAM (Random Access Memory), an external storage unit, and the like, an interface (I/F) 33 for connection with the PLC 21, a display unit 34 such as a liquid-crystal display, an input unit 35 such as a keyboard and a mouse, and a bus 36 for data transfer between each unit.

The PLC 21 performs control corresponding to a sequence program transmitted from the engineering tool 10. The PLC 21 transmits a control signal to an external device to be controlled. The PLC 21 monitors the operating state of the external device by receiving a detection signal from a sensor 22 or the like. The sensor 22 is connected to the PLC 21.

The engineering tool 10 includes a program editing unit 11, a label setting management unit 12, and an error number management unit 13. The program editing unit 11 is a functional part that edits a sequence program. The label setting management unit 12 is a functional part that manages the setting of a label. The allocation of a label to a device is set in accordance with the configuration or the like of the device to be controlled. When editing a sequence program, the program editing unit 11 designates a device according to the label selected and allocated to the device.

The error number management unit 13 is a functional unit that stores a database that manages error numbers. An error number is a number for identifying an individual processing in which an error has been detected. The error number management unit 13 stores an error number associated with an error message describing the error.

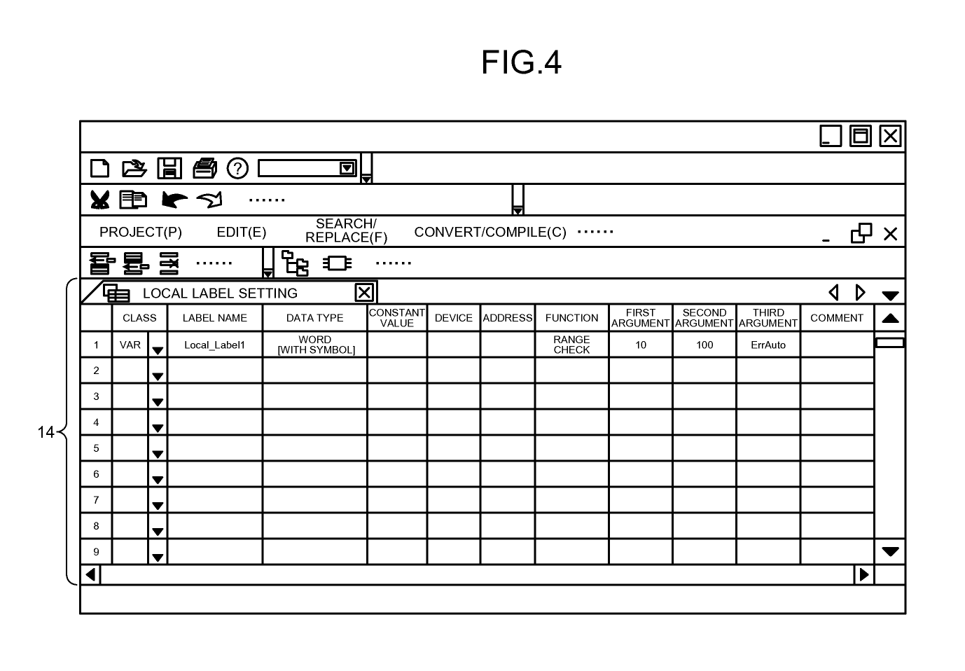

FIG. 4 is a diagram illustrating an exemplary operation screen including a label editor. The operation screen is displayed on the display unit 34 included in the PC 20. A label editor 14 is displayed in the operation screen by a menu bar being operated on the operation screen. The label editor 14 receives an operation for the label setting management unit 12 to set a label. Additionally, the label editor 14 displays the settings of labels managed by the label setting management unit 12.

The label editor 14 has a label registration function. The label registration function is a function that registers information that does not involve sequence program processing such as class, data type, a constant value, a variable such as a device and an address, and a comment, with a label name being used as a key. The label editor 14 also has a function of registering sequence program processing for each label, in addition to the label registration function.

A program editor, not illustrated, is displayed in the operation screen by performing an operation on the menu bar in the operation screen. The program editor receives an operation for editing a program. Additionally, the program editor displays the sequence program being edited by the program editing unit 11.

The label editor 14 is provided with a worksheet including rows and columns. The worksheet includes a sheet header, which indicates, for example, a “local label setting”. Each row of the worksheet indicates a row number. Each row number of the worksheet represents a local label number to be assigned to a label.

The columns of the illustrated worksheet indicate, sequentially from the left, the item names of “class”, “label name”, “data type”, “constant value”, “device”, “address”, “function”, “first argument”, “second argument”, “third argument”, and “comment”.

A label is defined by the items under “class”, “label name”, and “data type”. The items under “constant value”, “device”, and “address” are related to a device to which the label is allocated.

The item under “function” indicates individual processing performed by the device as a function corresponding to the individual processing. The items under “first argument”, “second argument”, and “third argument” indicate arguments that serve as accompanying information on the individual processing. The item under “comment” indicates a supplementary description of the setting of a label. By using an argument, such as a “first argument”, a “second argument”, and a “third argument”, the “function” itself is enabled to change its operating range or the like with the argument serving as a parameter.

The label editor 14 has a part that consists of the rows of the items “function”, “first argument”, “second argument”, and “third argument” and that functions as individual processing of a setting unit in the label setting management unit 12. The individual processing setting unit sets the individual processing performed by a device as designated by a label. It does this by associating a function corresponding to the individual processing with the label.

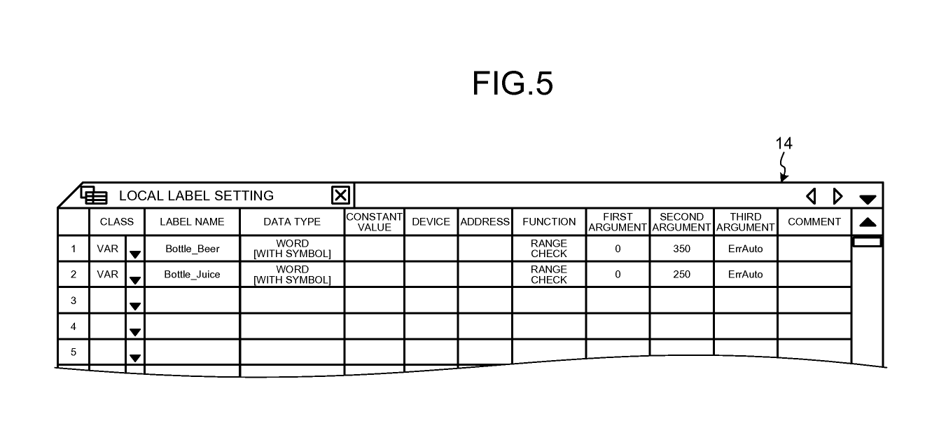

FIG. 5 is a diagram illustrating example settings of labels. This example indicates a label “Bottle_Beer” set for the liquid quantity of a beer bottle and a label “Bottle_Juice” set for the liquid quantity of a juice bottle.

The label with a local label number “1” is defined as a class “VAR”, the label name “Bottle_Beer”, and a data type “word [with symbol]”. The label with a local label number “2” is defined as a class “VAR”, the label name “Bottle_Juice”, and a data type “word [with symbol]”.

The function “range check” set for the two labels is to check whether a liquid quantity is within a certain range. The individual processing by this function is monitoring processing for monitoring, by comparing with an actual range of use, the operating state of a device to be controlled by a sequence program. The individual processing setting unit is capable of setting a function, which corresponds to individual processing, in association with a label.

The first arguments represent the minimum values of ranges of the liquid quantities, which are the actual ranges of use. The second arguments represent the maximum values of ranges of the liquid quantities, which are the actual ranges of use. The first arguments and the second arguments are arguments serving as the accompanying information of the individual processing. The individual processing setting unit is capable of setting an argument, which serves as accompanying information of individual processing, in association with a label.

The third arguments represent a setting for the assignment of an error number to an error detected with the range check. The third argument “ErrAuto” represents automatic assignment of an error number. The individual processing setting unit is capable of setting an operation, which is to register information for identifying individual processing that is monitoring processing as the individual processing in which an error has been detected, in association with a label. In this example, the individual processing in which the operating state of the device being controlled is outside the actual range of use is handled as an error.

In the example settings of the labels illustrated in FIG. 5, the individual processing to check whether the liquid quantity of a beer bottle is within the range of 0 ml to 350 ml is programmed for the device designated by the label “Bottle_Beer”. The individual processing by this program handles an instance where the liquid quantity exceeds the range of 0 ml to 350 ml as an error. The program editing unit 11 automatically assigns an error number for this individual processing.

The individual processing to check whether the liquid quantity of a juice bottle is within the range of 0 ml to 250 ml is programmed for the device designated by the label “Bottle_Juice”. The individual processing by this program handles an instance where the liquid quantity exceeds the range of 0 ml to 250 ml as an error. The program editing unit 11 automatically assigns an error number for this individual processing.

The error number management unit 13 provides error numbers for the labels “Bottle_Beer” and the “Bottle_Juice”. In accordance with the third argument “ErrAuto”, the error number management unit 13 allocates an unused number having no registered label as appropriate to each of the labels in the label setting management unit 12. When a numeric value is set as the third argument, the individual processing setting unit sets this numeric value as the error number.

For the individual processing to monitor, by comparing with an actual range of use, the operating state of a device to be controlled, the engineering tool 10 handles the individual processing in which the operating state of the device being controlled is outside the actual range of use as an error. However, the monitoring is not limited to this. The engineering tool 10 may, for example, handle the individual processing as on object for a warning or interruption processing, instead of an error. The individual processing setting unit is capable of setting an operation, which is for registering an ID for a warning number or the interruption processing as information for identifying the individual processing in which the operating state is outside the actual range of use, in association with a label.

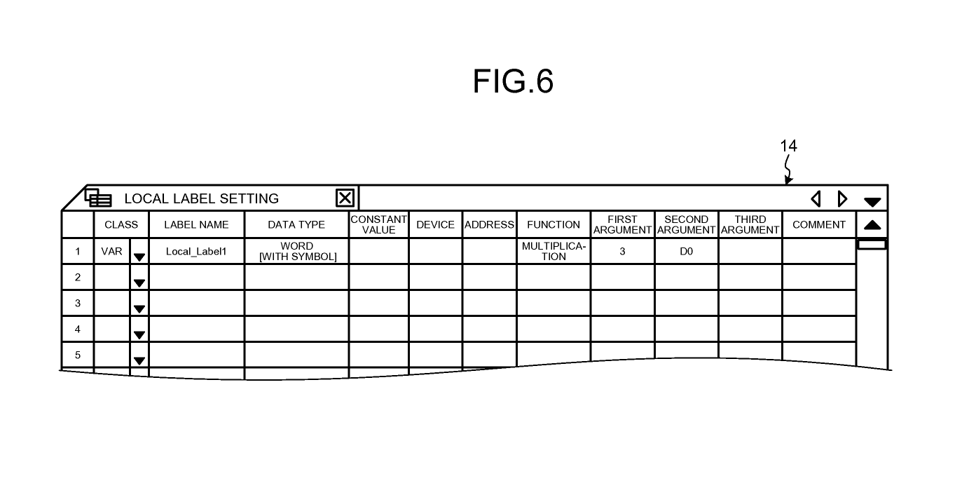

The individual processing set by the individual processing setting unit is not limited to the range check. FIG. 6 is a diagram illustrating another example setting of a label. In this example, the individual processing setting unit sets a function of multiplication. The first argument represents a numeric value by which to multiply the label name “Local_Label1”. The second argument represents the result of the multiplication. In this example, the individual processing to perform the calculation of D0=(Local_Label1)×3 is programmed.

The individual processing setting unit is capable of setting any function as individual processing to be performed by a device. The function that the individual processing setting unit is capable of setting is not limited to those using an argument as accompanying information of the individual processing. The individual disposal setting unit may set a function that needs no argument.

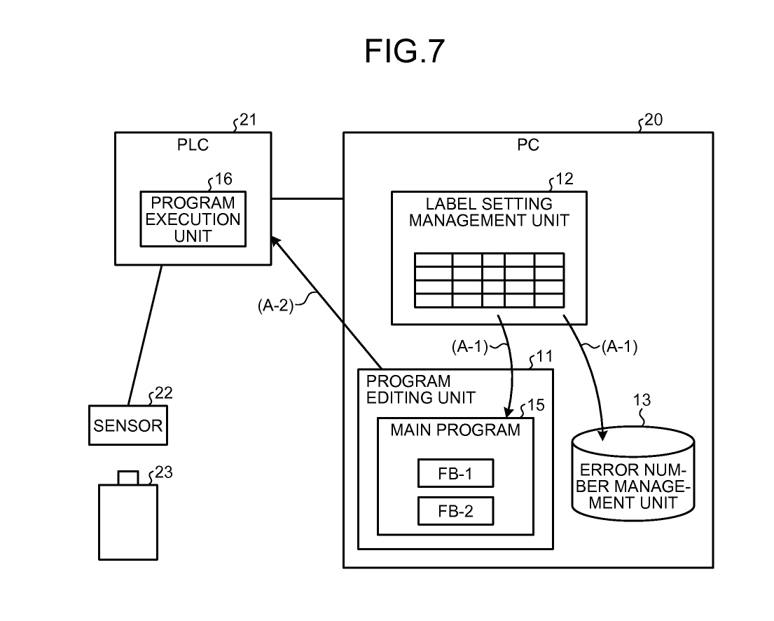

With reference to FIGS. 7 to 9, the operation procedures of the engineering tool and the PLC will be described here. FIG. 7 is a diagram explaining program editing and transmission of a sequence program to the PLC by the engineering tool. An external device controlled by the PLC 21 injects liquid into a bottle 23. The sensor 22 detects the quantity of the liquid injected into the bottle 23.

For example, operation to the label editor 14 sets the labels as illustrated in FIG. 5 in the label setting management unit 12. Pasting the labels in the label editor 14 onto the program editor allows the program editing unit 11 to convert the functions, which are associated with the labels in the label setting management unit 12, into programs and incorporate the programs into a sequence program.

The program editing unit 11 converts the function associated with the label “Bottle_Beer” read from the label setting management unit 12 into an FB-1, which is a function block. The program editing unit 11 converts the function associated with the label “Bottle_Juice” read from the label setting management unit 12 into an FB-2, which is also a function block. The program editing unit 11 registers the FB-1 and the FB-2 in a main program 15 (A-1).

The label setting management unit 12 instructs the error number management unit 13 to provide error numbers in accordance with the third argument “ErrAuto” illustrated in FIG. 5 (A-1). The error number management unit 13 provides unused numbers having no registered label as appropriate for the labels in the label setting management unit 12. For example, the error number management unit 13 allocates an error number “1” to the label “Bottle_Beer”. The error number management unit 13 allocates an error number “2” to the label “Bottle_Juice”.

The program editing unit 11 assigns the error numbers provided by the error number management unit 13 to the labels. The program editing unit 11 registers the error numbers assigned to the labels in the error number management unit 13 together with error messages. The program editing unit 11 outputs the main program 15 that incorporates the FB-1, which includes the error number “1”, and the FB-2, which includes the error number “2”. The PC 20 transmits a sequence program including the main program 15 to the PLC 21 (A-2).

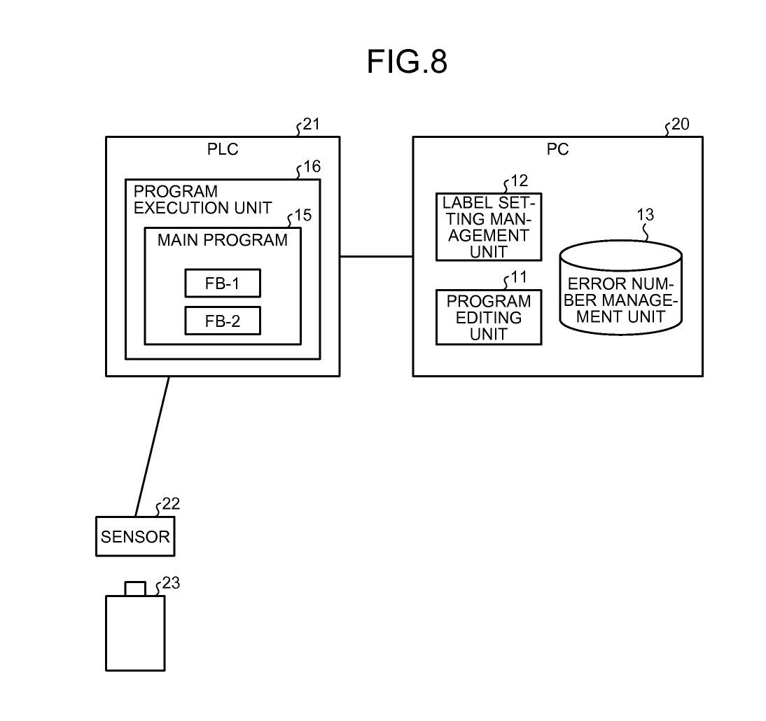

FIG. 8 is a diagram illustrating the state in which the sequence program is operating in the PLC. A program execution unit 16 executes the sequence program including the main program 15. The program execution unit 16 executes control for the range check in accordance with the FB-1 and the FB-2. The PLC 21 enables the sensor 22 to detect the quantity of the liquid injected into the bottle 23.

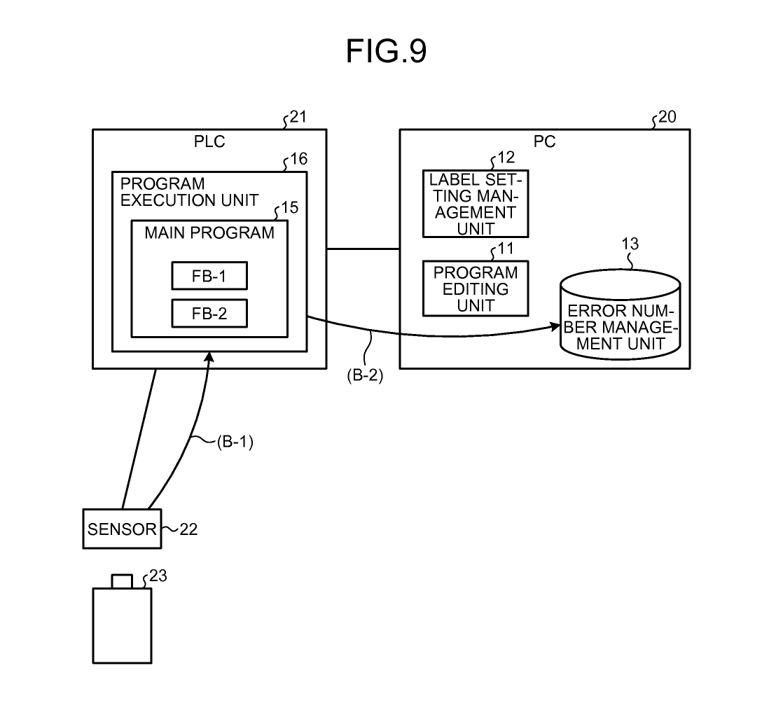

FIG. 9 is a diagram explaining the operation at the occurrence of an error during the operation of the sequence program in the PLC. The sensor 22 outputs the result of the detection to the PLC when needed (B-1). For example, when the bottle 23 is a juice bottle, the sensor 22 detects the liquid quantity of 260 ml.

On receipt of the result of the detection from the sensor 22, the error number “2” (ERROR_NO=2) is set in the PLC 21 through the processing corresponding to the FB-2 performed by the program execution unit 16. The PLC 21 transmits the error number “2” to the PC 20. The error number management unit 13 compares the error number transmitted to the PC 20 from the PLC 21 with error numbers managed by the error number management unit 13 (B-2).

The error number management unit 13 stores an error message associated with the error number “2”. This error message describes an error to the effect that the liquid quantity for the juice bottle exceeds the actual range of use.

The PC 20 reads the error message associated with the error number “2” from the error number management unit 13. The PC 20 determines from this error message that the liquid quantity for the juice bottle has exceeded the actual range of use. The PC 20 displays the description of the error message on the operation screen.

The use of the engineering tool 10 including the error number management unit 13, which manages error numbers and error messages, enables the processing load on the PLC 21 to be reduced when making a unit available for addressing an error on each occasion of individual processing. This allows easy troubleshooting for the PLC 21. Note that the PLC 21, instead of the engineering tool 10, may assign an error number.

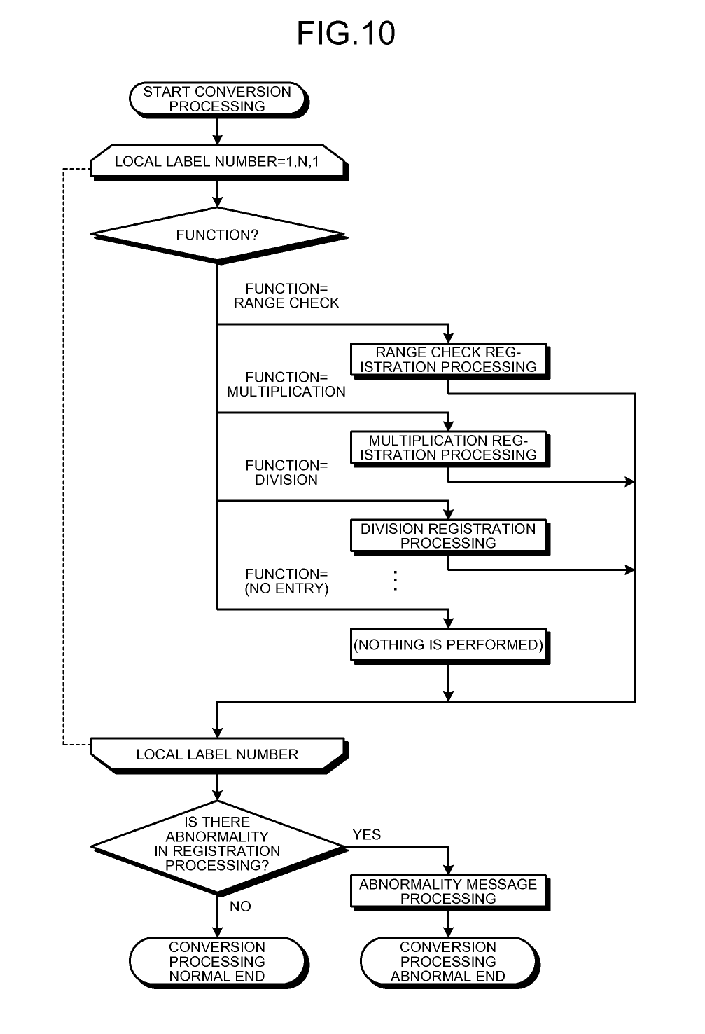

FIG. 10 is a flowchart of the procedure for converting a setting managed by the label setting management unit into a program for individual processing. It is assumed that the label setting management unit 12 can manage labels to which local label numbers 1 to N are assigned. The maximum value N of the local label numbers is a value corresponding to the specification of the label setting management unit 12. Here, N is an integer that is equal to or greater than two.

The program editing unit 11 reads a “function” for each local label number sequentially. The program editing unit 11 distinguishes “functions” read for the local label numbers and performs registration processing to register function blocks. Note that the “function” refers to calculation or control processing in a sequence program for a certain label.

For example, when the “function” is “range check”, the program editing unit 11 performs the registration processing for a function block of the range check. When the “function” is “multiplication”, the program editing unit 11 performs the registration processing for a function block of the multiplication. When the “function” is “division”, the program editing unit 11 performs the registration processing for a function block of the division. The program editing unit 11 performs the registration processing corresponding to the “functions” for all the local label numbers. When there is no entry under “function”, the program editing unit 11 performs nothing in relation to the registration processing.

When the program editing unit 11 has finished the registration processing for function blocks for all the local label numbers, the program editing unit 11 determines whether there has been any abnormality in the registration processing. If there is no abnormality on all occasions of the registration processing, the program editing unit 11 determines that the conversion processing from the functions set in the label setting management unit 12 to programs for the individual processing is normal and finishes the conversion processing.

Meanwhile, if there is even one abnormality on any of all the occasions of the registration processing, the program editing unit 11 determines that the conversion processing is abnormal and performs abnormality message processing. The abnormality message processing is processing for displaying a message to the effect that the conversion processing is abnormal on, for example, the operation screen. In this manner, the program editing unit 11 determines that the conversion processing from the functions set in the label setting management unit 12 to the programs for the individual processing is abnormal and finishes the conversion processing.

The registration processing for a function block will now be described in detail. Here, the registration processing for the function block of the range check is described as an example. Description is omitted of the registration processing for functions other than the range check.

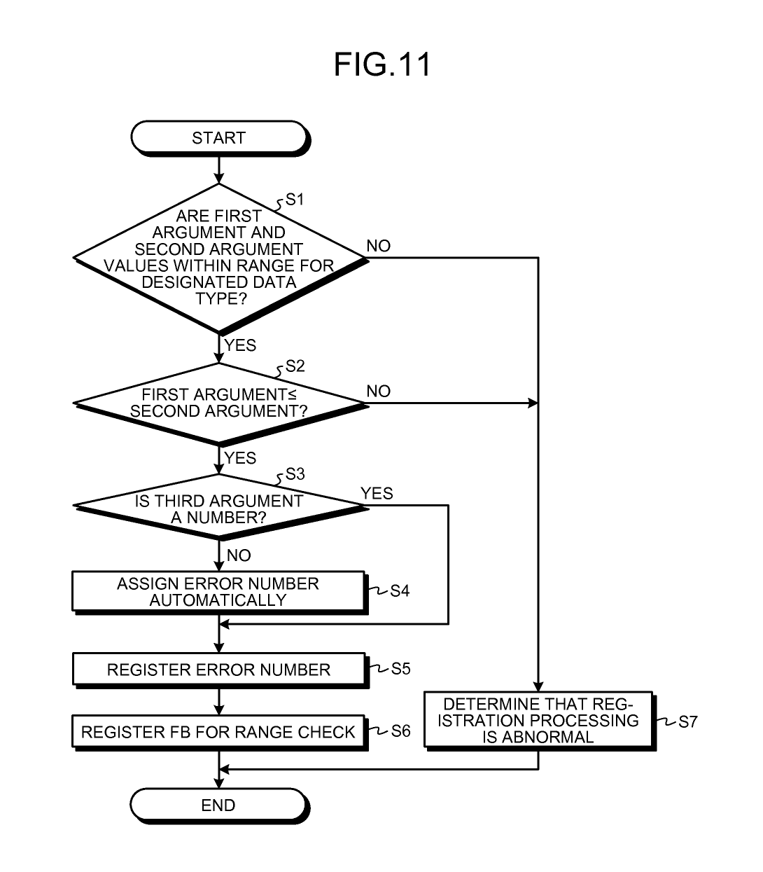

FIG. 11 is a flowchart of the procedure for the registration processing for the range check. The program editing unit 11 determines whether the first argument and the second argument are values that are within a range for the designated data type (step S1). If the first argument and the second argument are not within the range (No in step S1), the program editing unit 11 determines that the registration processing is abnormal (step S7).

If the first argument and the second argument are within the range (Yes in step S1), the program editing unit 11 determines whether the relationship where the first argument ≦the second argument is satisfied (step S2). In steps S1 and S2, the program editing unit 11 verifies whether values that allow the correct range check are set as the first argument and the second argument.

If the relationship where the first argument the second argument is not satisfied (No in step S2), the program editing unit 11 determines that the registration processing is abnormal (step S7). If the relationship where the first argument ≦the second argument is satisfied (Yes in step S2), the program editing unit 11 determines whether the third argument is a number (step S3). It is assumed that the third argument is either a numeric value that is used as an error number or “ErrAuto”. The program editing unit 11, in step S3, determines whether an error number be assigned automatically.

If the third argument is a number (Yes in step S3), the program editing unit 11 registers the number as an error number in the error number management unit 13 (step S5). If the third argument is not a number, that is, if it is “ErrAuto” (No in step S3), the program editing unit 11 acquires an unused number from the error number management unit 13. The program editing unit 11 uses the unused number as the error number to assign an error number for the range check automatically (step S4). The program editing unit 11 registers the error number in the error number management unit 13 (step S5). In this manner, the program editing unit 11 is capable of registering an error number per function automatically. This enables the engineering tool 10 to register error numbers with ease.

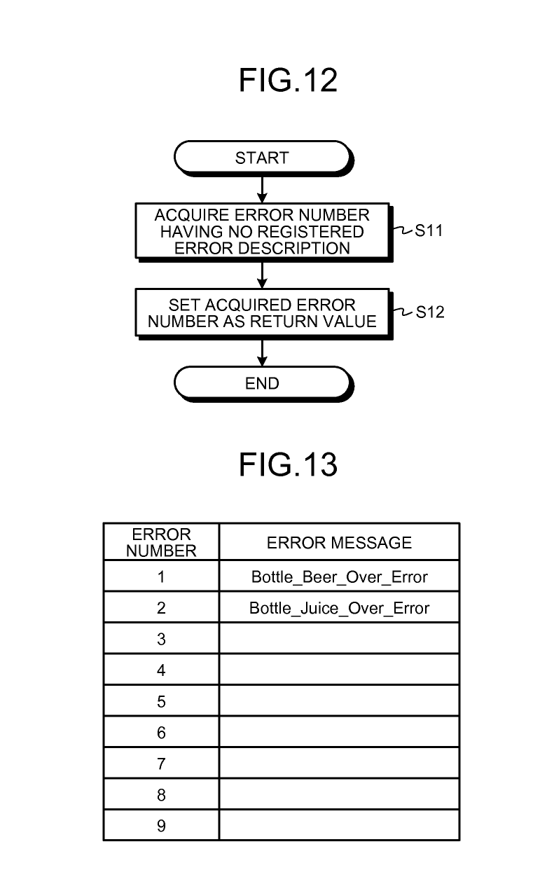

FIG. 12 is a flowchart explaining the automatic assignment of an error number. The program editing unit 11 acquires an error number having no registered error message describing of an error in the error number management unit 13 (step S11). The program editing unit 11 sets the error number acquired in step S11 as a return value to the error number management unit 13 (step S12).

FIG. 13 is a diagram illustrating example error numbers and error messages stored by the error number management unit. A character string “(label name)_(abbreviated name of function)_Error” is registered in the error number management unit 13 as an error message. In this example, “Over” is the abbreviated name of a function for the “range check”.

The character string “Bottle_Beer Over Error” registered for the error number “1” is an error message describing an error to the effect that the liquid quantity for the beer bottle exceeds the actual range of use. The character string “Bottle_Juice Over Error” registered for the error number “2” is an error message describing an error to the effect that the liquid quantity for the juice bottle exceeds the actual range of use.

In the registration processing for the range check, the engineering tool 10 is capable of registering an error number in accordance with a setting in the label setting management unit 12. The engineering tool 10 provides the capability to manage error numbers with ease without separately registering an error number.

The next section refers back to FIG. 11. The program editing unit 11 registers the function block (FB) for the range check in the main program 15 (see FIG. 7) (step S6). After step S6 or S7, the program editing unit 11 finishes the registration processing for the range check.

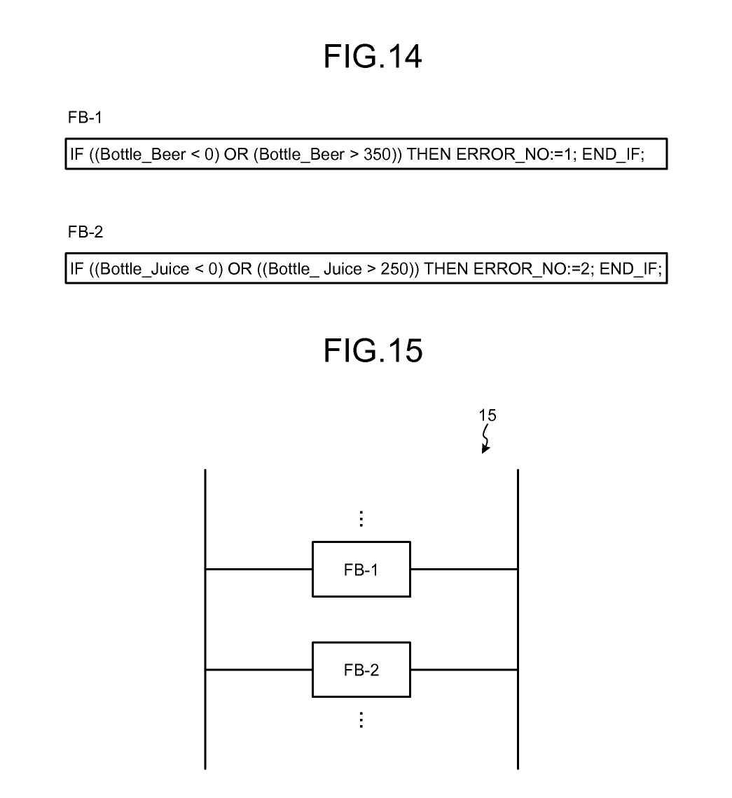

FIG. 14 is a diagram illustrating example function blocks to be registered for the range check. The program editing unit 11 generates a function block by using a value set in the label setting management unit 12.

For example, the FB-1 to be registered for the local label number “1” is generated by using values set for the label “Bottle_Beer”, for example, “Bottle_Beer”, “0”, and “350”. The FB-2 to be registered for the local label number “2” is generated by using values set for the label “Bottle_Juice”, for example, “Bottle_Juice”, “0”, and “250”. Note that “ERROR_NO” included in the FB-1 and the FB-2 is a label variable indicative of an error number to be set in the PLC 21 at the occurrence of an error.

FIG. 15 is a diagram illustrating the main program that incorporates the function blocks. The program editing unit 11 generates the main program 15 that incorporates the FB-1 and the FB-2 illustrated in FIG. 14 by converting the functions associated with the labels in the label setting management unit 12 to the programs.

The engineering tool 10 according to the present invention is capable of setting individual processing performed by a device designated by a label. It does this by allowing the individual processing setting unit to associate a function corresponding to the individual processing with the label. The engineering tool 10 can eliminate the need for setting individual check logic in a user program, such as a ladder. The engineering tool 10 provides the capability to reduce the size of a sequence program. The workload of editing a sequence program can be reduced for an operator.

The engineering tool 10 centrally manages a label and individual processing set for a device in the label setting management unit 12. An operator can designate a device and set individual processing in a collective manner by using the label editor.

In the label editor 14, labels are often registered with the label names distinguished or organized in accordance with, typically, the description of processing or the devices to be controlled. A label name includes, for example, “Bottle” at the beginning of the label name and will be distinguished in accordance with the processing. Here, to perform processing (a function) identical with that of a label distinguished in accordance with the processing, the use of the label editor 14 allows labels to be displayed with the label names arranged (sorted) with ease. With such a display, an operator can register processing (a function) for a label easily by making entries in a similar manner as in a table. An operator can register processing (a function) for a certain label more efficiently in the present embodiment in comparison with the conventional approach that requires programming using an editor for each label. Furthermore, the operator can check processing already registered easily by sorting labels in the label editor 14.

In this manner, the engineering tool 10 has the capability for simplified setting and management of individual processing performed by a device and simplified program editing. Additionally, the engineering tool 10 provides the capability to reduce the size of a sequence program.

The PLC 21 has the capability to perform control on the basis of a setting in the individual processing setting unit of the engineering tool 10. The PLC 21 can perform efficient control by executing a sequence program having a reduced size.

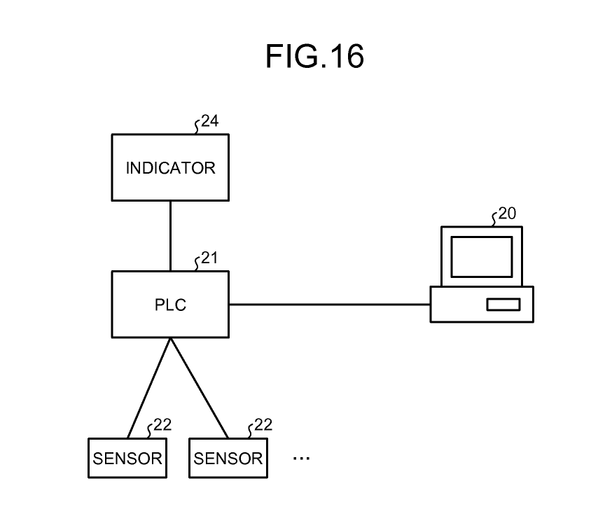

FIG. 16 is a diagram illustrating a system including a PLC, a PC, an indicator, and a plurality of sensors. An indicator 24 and a plurality of sensors 22 are connected to the PLC 21. The indicator 24 displays the working state of each external device that is to be controlled and allows setting of and operating of the devices. The sensors 22 are sensors of various types that detect the working state of each external device. The sensors 22 may include, for example, a vision sensor, a pressure sensor, and a proximity sensor.

The engineering tool 10 edits a sequence program to be run in the PLC system that includes the indicator 23 or the plurality of sensors 22. In this case, the engineering tool 10 also has the capability to provide simplified setting and management of individual processing performed by a device and simplified program editing. The engineering tool 10 also provides the capability to reduce the size of a sequence program.

### REFERENCE SIGNS LIST

10 engineering tool, 11 program editing unit, label setting management unit, 13 error number management unit, 14 label editor, 15 main program, 16 program execution unit, 20 PC, 21 PLC, 22 sensor, 23 bottle, 24 indicator, 31 arithmetic unit, 32 storage unit, 33 I/F, 34 display unit, 35 input unit.

1. An engineering tool, comprising:
a program editing unit
designating a device by selecting a label allocated to the device and
editing a sequence program; and
a label setting management unit that manages a setting of the label, wherein
the label setting management unit comprises
an individual processing setting unit that is capable of setting, by associating a function corresponding to the individual processing with the label, individual processing on the device designated by the label,
the individual processing setting unit allows a label editor that displays the setting of the label managed by the label setting management unit to receive setting for the individual processing, and
the program editing unit converts the function associated with the label by the individual processing setting unit into a program and incorporates the program that is converted into the sequence program.

2. The engineering tool according to claim 1, wherein
the individual processing setting unit is further capable of setting, in association with the label, an argument that serves as accompanying information of the individual processing.

3. The engineering tool according to claim 2, wherein
the individual processing setting unit is further capable of setting, in association with the label and when the individual processing is monitored by a comparison between an operating state of the device to be controlled by the sequence program and an actual range of use, an operation to register information for identifying the individual processing in which the operating state is outside the actual range of use.

4. The engineering tool according to claim 1, further comprising an error number management unit that manages, when the individual processing is monitored by a comparison between an operating state of the device to be controlled and the sequence program with an actual range of use, an error number that is information for identifying the individual processing in which the operating state is outside the actual range of use.

5. The engineering tool according to claim 4, wherein
the program editing unit is capable of registering the error number for each of the functions automatically.

6. A programmable logic controller comprising a program execution unit that executes a sequence program, the programmable logic controller performing control corresponding to the sequence program, wherein
the sequence program is edited after a device is designated by selecting a label allocated to the device in an engineering tool,
a setting of the label is managed in the engineering tool and individual processing on the device designated by the label is set in the engineering tool by associating a function corresponding to the individual processing with the label,
the function associated with the label is converted to a program and then incorporated into the sequence program, and
the program execution unit performs, by executing the sequence program, the individual processing corresponding to the function associated with the label.
